(19) United States
(12) Patent Application Publication
(10) Pub. No.: US 2016/0182377 A1
(43) Pub. Date: Jun. 23, 2016

(54) DATA TRANSMISSION METHOD AND DATA TRANSMISSION APPARATUS

(71) Applicant: Hitachi, Ltd., Tokyo (JP)

(72) Inventor: Kenji KURIBAYASHI, Tokyo (JP)

(73) Assignee: Hitachi, Ltd., Tokyo (JP)

(21) Appl. No.: 14/906,813

(22) PCT Filed: Feb. 28, 2014
(86) PCT No.: PCT/JP2014/055034

§ 371 Date: Jan. 21, 2016

(51) Int. Cl. H04L 12/801; H04L 29/08

(52) U.S. Cl. CPC H04L 47/12; H04L 67/06

(57) ABSTRACT

An object is to enable transmission of necessary data in an appropriate volume suitable for a condition of a recipient side. A data transmission apparatus includes: an auxiliary memory device 101 storing information 125 on transmission data 51 acquired from a data transmission source 50, a condition 126 of a client 200 as a data transmission destination, and information on multiple data reduction methods 127; and an arithmetic device 104 configured to execute a pattern determination process of calculating, for each pattern including one or a combination of more than one of the data reduction methods 127, a transmission data volume of the transmission data 51 after reduction with application of the pattern concerned, and determining a pattern capable of reduction to or below a transmission data limitation volume suitable for the condition of the client 200, and a data transmission process of executing a reduction process on the transmission data by using the data reduction method of the determined pattern, and sending the client the transmission data 52 after the reduction process.

### TECHNICAL FIELD

The present invention relates to a data transmission method and a data transmission apparatus.

### BACKGROUND ART

In recent years, attention has been increasingly focused on use of big data. A system generating or using such big data is expected to perform not only data reception and transmission between terminals operated by persons, but also data transmission from machines such as sensors and computers to terminals operated by persons. Since the machines are able to perform data transmission automatically with high frequency in response to generations and productions of data, an explosive growth is expected in the number of data receptions at each of the foregoing terminals as a destination of such data transmission.

In the meantime, persons who should check received data on the foregoing terminals have a problem in that they are prone to overlook necessary data when the number of data received is huge. To address this problem, there have been proposed a conventional technique of causing a transmitter side to generate a single summary from a multiple number of transmission data and to transmit the summary to a recipient side, and a conventional technique of transmitting transmission data only when the content of the transmission data is changed.

As one of such techniques, the following technique has been proposed in which when mails containing notifications of events are received, the number of notifications to be read is reduced for the purpose of improving usability. More specifically, in a proposed method (see Patent Document 1), for example, if event-related data received in response to the occurrence of an event matches a conditional expression in a profile associated with the event, a notification of the event is stored in a queue. Then, upon arrival of the earliest transfer time among transfer times set in the respective notifications stored in the queue, all the notifications stored in the queue are sent as a single notification to a client of a recipient.

### CITATION LIST

### Patent Literature

### [PTL 1] Japanese Patent Application Publication No. 2012-133557

### SUMMARY OF INVENTION

### Technical Problem

In the conventional technique, however, since the data reduction method applied to reduction target data is static, some kinds of reduction target data cannot be reduced sufficiently due to their characteristics or contents. This may cause a situation where a large volume of data is transmitted to the terminal of a person regardless of the condition on the recipient side. In another case, a reverse situation may occur where data which must not be eliminated in principle is eliminated, and then the data excluding the eliminated data is transmitted. Accordingly, there is a possibility that a person who checks received data on the terminal may overlook necessary data in a large volume of received data, or even cannot recognize the existence of the necessary data because the necessary data is not included in the received data to begin with.

Hence, the present invention has an object to provide a technique of transmitting necessary data in an appropriate volume suitable for a condition of a recipient side.

### Solution to Problem

According to a feature of a data transmission method of the present invention solving the aforementioned problems, an information processing apparatus, which includes a memory device that stores information on transmission data, a condition of a client as a data transmission destination, and information on a plurality of data reduction methods, executes: a pattern determination process of calculating, for each pattern including one or a combination of more than one of the data reduction methods, a transmission data volume of the transmission data after reduction with application of the pattern concerned, and determining a pattern capable of reduction to or below a transmission data limitation volume suitable for the condition of the client; and a data transmission process of executing a reduction process on the transmission data by using the data reduction method of the determined pattern, and sending the client the transmission data after the reduction process.

In addition, according to a feature of a data transmission apparatus of the present invention, the data transmission apparatus includes: a memory device that stores information on transmission data, a condition of a client as a data transmission destination, and information on a plurality of data reduction methods; and an arithmetic device configured to execute a pattern determination process of calculating, for each pattern including one or a combination of more than one of the data reduction methods, a transmission data volume of the transmission data after reduction with application of the pattern concerned, and determining a pattern capable of reduction to or below a transmission data limitation volume suitable for the condition of the client, and a data transmission process of executing a reduction process on the transmission data by using the data reduction method of the determined pattern, and sending the client the transmission data after the reduction process.

### Advantageous Effects of Invention

According to the present invention, it is possible to transmit necessary data in an appropriate volume suitable for a condition of a recipient side.

### BRIEF DESCRIPTION OF DRAWINGS

FIG. 1 is a configuration diagram of a network including a server as a data transmission apparatus in Embodiment 1.

FIG. 2 is a diagram illustrating a hardware configuration example of the server in Embodiment 1.

FIG. 3 is a diagram illustrating a configuration example of boilers and sensors as a data transmission source in Embodiment 1.

FIG. 4 is a diagram illustrating an example of transmission data in Embodiment 1.

FIG. 5 is a diagram illustrating an example of a transmission data storage table in Embodiment 1.

FIG. 6 is a diagram illustrating an example of a management performance control table in Embodiment 1.

FIG. 7 is a diagram illustrating an example of a transmission volume reduction scheme storage table in Embodiment 1.

FIG. 8 is a flow chart presenting a procedure example 1 of a data transmission method in Embodiment 1.

FIG. 9 is a flow chart presenting a procedure example 2 of the data transmission method in Embodiment 1.

FIG. 10 is a flow chart presenting a procedure example 3 of the data transmission method in Embodiment 1.

FIG. 11 is a diagram illustrating an example of a transmission volume reduction scheme combination table in Embodiment 1.

FIG. 12 is a diagram presenting a procedure example 4 of the data transmission method in Embodiment 1.

FIG. 13 is a diagram illustrating an example 1 of an execution result table in Embodiment 1.

FIG. 14 is a diagram illustrating an example 2 of the execution result table in Embodiment 1.

FIG. 15 is a diagram illustrating an example 3 of the execution result table in Embodiment 1.

FIG. 16 is a diagram illustrating an example of an output screen in Embodiment 1.

FIG. 17 is a configuration diagram of a network including a server as a data transmission apparatus in Embodiment 2.

FIG. 18 is a diagram illustrating an example of a related data table in Embodiment 2.

FIG. 19 is a flow chart presenting a procedure example 1 of a data transmission method in Embodiment 2.

FIG. 20 is a diagram illustrating an example of a transmission volume reduction scheme combination table in Embodiment 2.

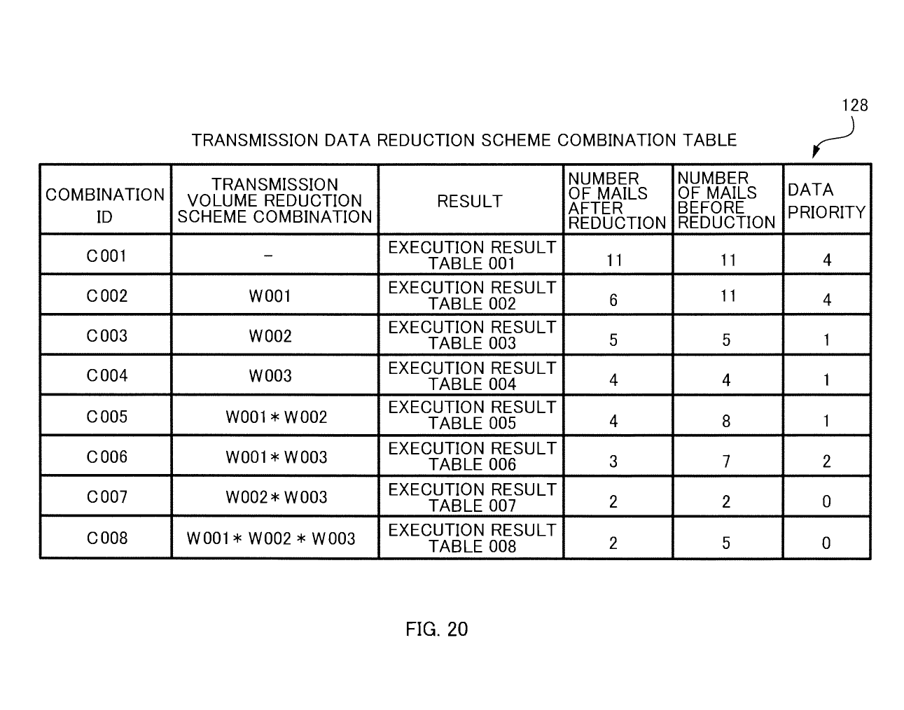

FIG. 21 is a flow chart presenting a procedure example 2 of the data transmission method in Embodiment 2.

FIG. 22 is a diagram illustrating an example of an output screen in Embodiment 2.

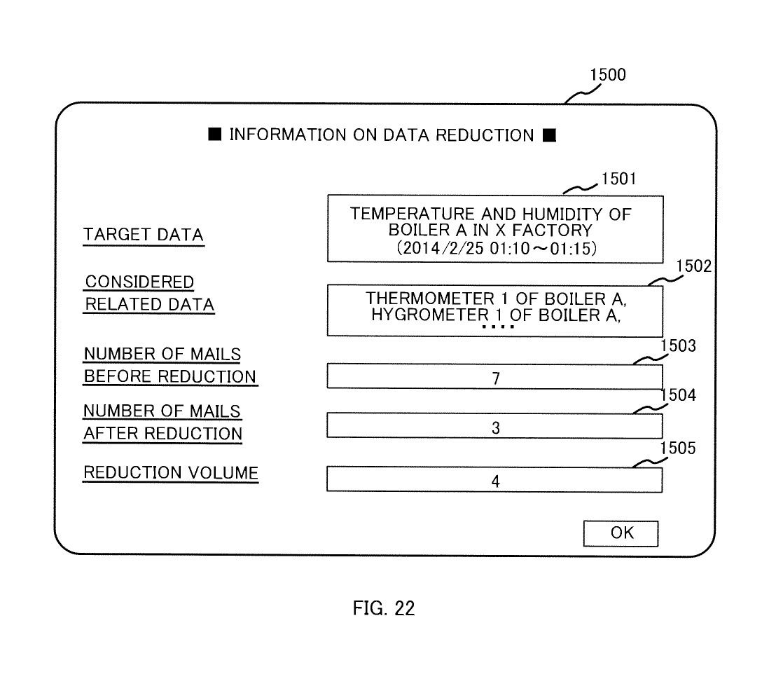

### DESCRIPTION OF EMBODIMENTS

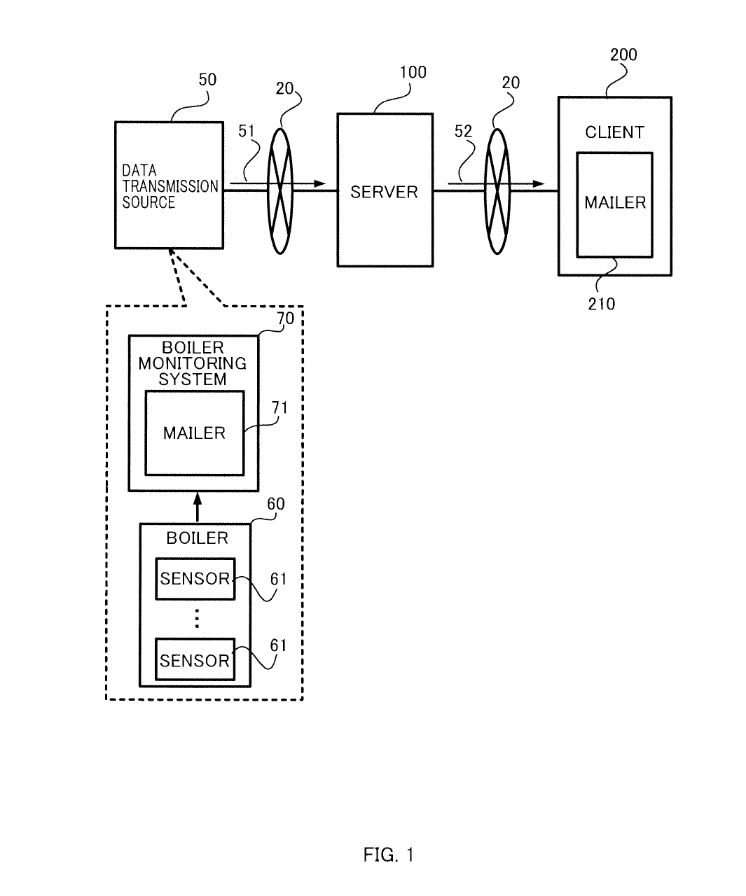

Hereinafter, detailed description is provided for embodiments of the present invention by using the drawings. FIG. 1 is a diagram illustrating a configuration example of a network including a server 100 as a data transmission apparatus of Embodiment 1. The server 100 as the data transmission apparatus illustrated in FIG. 1 is a computer apparatus for transmitting necessary data in an appropriate volume suitable for a condition of a recipient side.

A conceivable example of such server 100 is a mail delivery server coupled to a network 20, and configured to receive transmission data 51 from a data transmission source 50, perform a reduction process on the received transmission data 51, and then deliver the data after the reduction process, namely, post-reduction transmission data 52 to a client 200 as a data transmission destination. Meanwhile, a conceivable example of the data transmission source 50 in the present embodiment is a boiler monitoring system 70 configured to acquire measurement data from sensors 61 installed in each of boilers 60, and to transmit the acquired data as mails to the server 100 by means of a mailer 71.

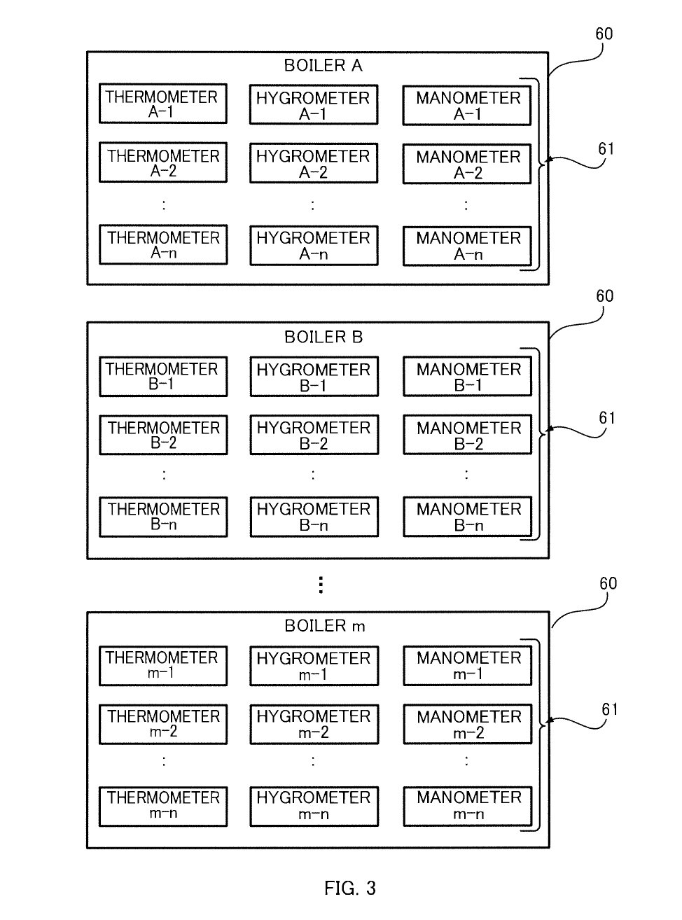

Here, a configuration example of the sensors 61 in the boilers 60 described above is illustrated in FIG. 3. In this example, multiple boilers, i.e., boilers A to m exist as the boilers 60, and thermometers A-1 to A-n, thermometers B-1 to B-n, or thermometers m-1 to m-n, hygrometers A-1 to A-n, hygrometers B-1 to B-n, or hygrometers m-1 to m-n, and manometers A-1 to A-n, manometers B-1 to B-n, or manometers m-1 to m-n are provided as the sensors 61 in each of the boilers 60. The aforementioned boiler monitoring system 70 sends the server 100 a mail of an alert issued in each of the sensors 60 of these thermometers, hygrometers, and manometers. Meanwhile, the client 200 is an information processing terminal used by a user who manages the conditions of the sensors 61 in all the multiple boilers 60.

The server 100 is the mail delivery server, and is configured to perform a proper reduction process on mails, i.e., the transmission data 51, received from the data transmission source 50 such as the aforementioned boiler monitoring system 70, and thereafter to deliver the resultant data as the post-reduction transmission data 52 to the client 200 designated as a destination of the mails. By means of its own mailer 210, the client 200 receives the mails, i.e., the post-reduction transmission data 52, delivered from the server 100, and allows the user to browse the mails. Needless to say, this application mode is merely one example. The present embodiment may be applied to any situation where a large volume of transmission data is generated, and the delivery forms of the transmission data 51 and the post-reduction transmission data 52 are not limited to mails, either.

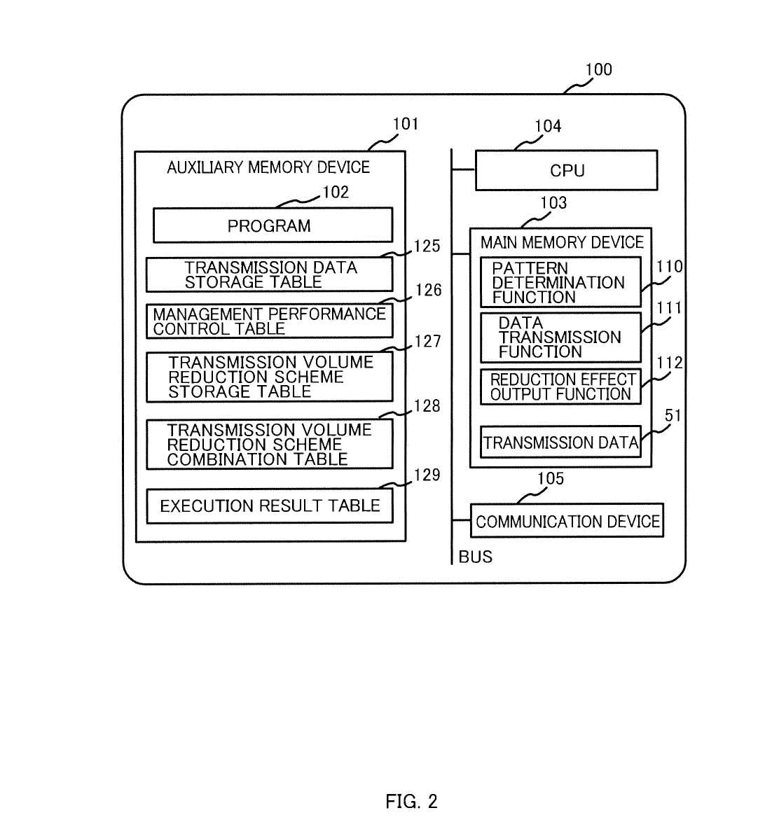

Moreover, a hardware configuration of the foregoing server 100 is one as described below. FIG. 2 is a diagram illustrating a hardware configuration example of the server 100 of Embodiment 1. The server 100 includes an auxiliary memory device 101 formed of a relevant non-volatile memory device such as a hard disk drive; a main memory device 103 formed of a volatile memory device such as a RAM; a CPU 104 (arithmetic device) that implements necessary functions 110 to 112 by loading a program 102 retained in the auxiliary memory device 101 to the main memory device 103 and executing the loaded program 102, and thereby preforms a total control of the server itself, and various determination, calculation and control processes; and a communication device 105 coupled to the network 20 and being in charge of processes for communications with other apparatuses. Here, it should be noted that the above auxiliary memory device 101 stores a transmission data storage table 125 storing information of the transmission data 51; a management performance control table 126 storing information on the condition of a client 200 of the data transmission destination; a transmission volume reduction scheme storage table 127 storing information on multiple transmission volume reduction methods; a transmission volume reduction scheme combination table 128; and an execution result table 129, all of which are to be described in detail later.

Next, description is provided for the functions 110 to 112 equipped in the server 100 as the data transmission apparatus of Embodiment 1. As described above, the functions to be described below can be said to be functions implemented by the CPU 104 executing the program 102 provided in the server 100, for example.

The server 100 has a pattern determination function 110 to: extract the information on the data reduction methods from the transmission volume reduction scheme storage table 127 in the auxiliary memory device 101; generate all the patterns each including one or a combination of more than one of the data reduction methods; for each of the generated patterns, calculate a transmission data volume of the transmission data 51 (the data stored in the transmission data storage table 125) after reduction with application of the pattern concerned; and determine a pattern capable of reduction to or below a transmission data limitation volume suitable for the condition of the client 200 (for example, the latest number of mails opened per unit time) extracted from the management performance control table 126.

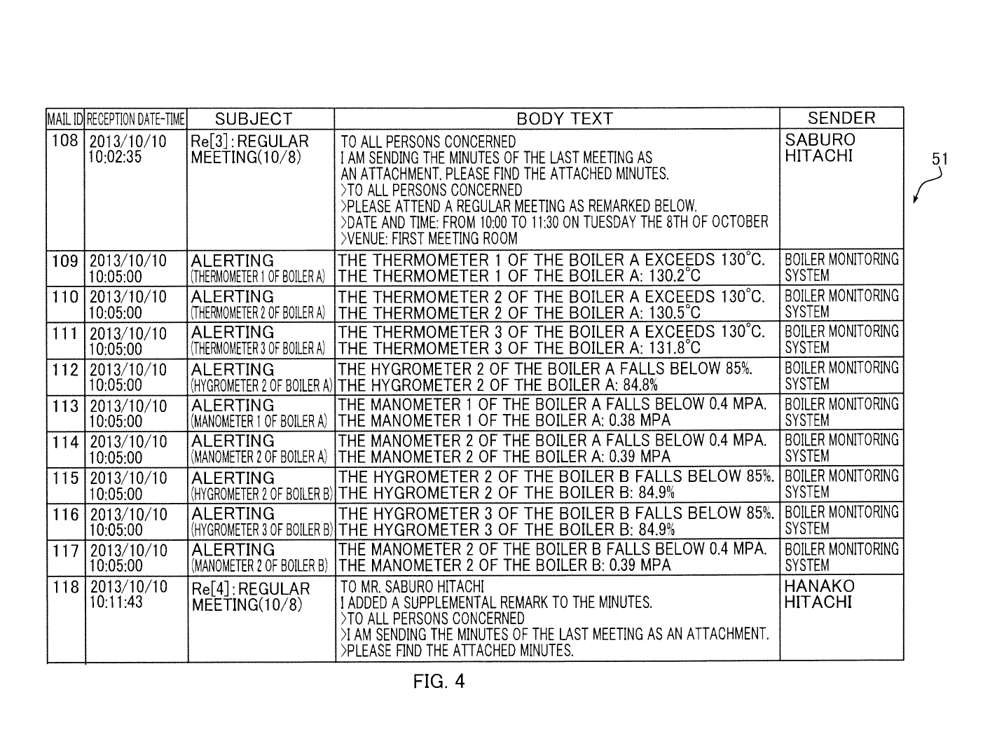

Note that the aforementioned server 100 has a function by which the transmission data 51 acquired from the data transmission source 50 via the communication device 105 is stored into the transmission data storage table 125 in the auxiliary memory device 101. In FIG. 4, an example of the transmission data 51 which the server 100 acquires from the foregoing boiler monitoring system 70 is presented as an example of the transmission data 51 which the server 100 acquires from the data transmission source 50, and temporarily stores in the main memory device 101. As in the example presented in FIG. 4, the transmission data 51 is an aggregate of mails received from the boiler monitoring system 70, and contains information items of a mail ID, a reception date-time, a subject, a body text, and a sender of each of the mails.

Here, it is preferably that, if two or more patterns are hit as the pattern capable of reduction to or below the foregoing limitation volume, the aforementioned pattern determination function 110 should determine the pattern leading to the largest transmission data volume after the reduction among the patterns thus hit.

In addition, the server 100 has a data transmission function 111 to: execute the reduction process on the transmission data 51 (the data stored in the transmission data storage table 125) by using the data reduction method in the pattern determined by the aforementioned pattern determination function 110; and transmit the transmission data after the reduction process, namely, the post-reduction transmission data 52 to the client 200.

Moreover, the server 100 has a reduction effect output function 112 to send the client 200 the transmission data volumes of the transmission data 51 before and after the reduction process with the application of the data reduction method of the pattern determined by the aforementioned pattern determination function 110.

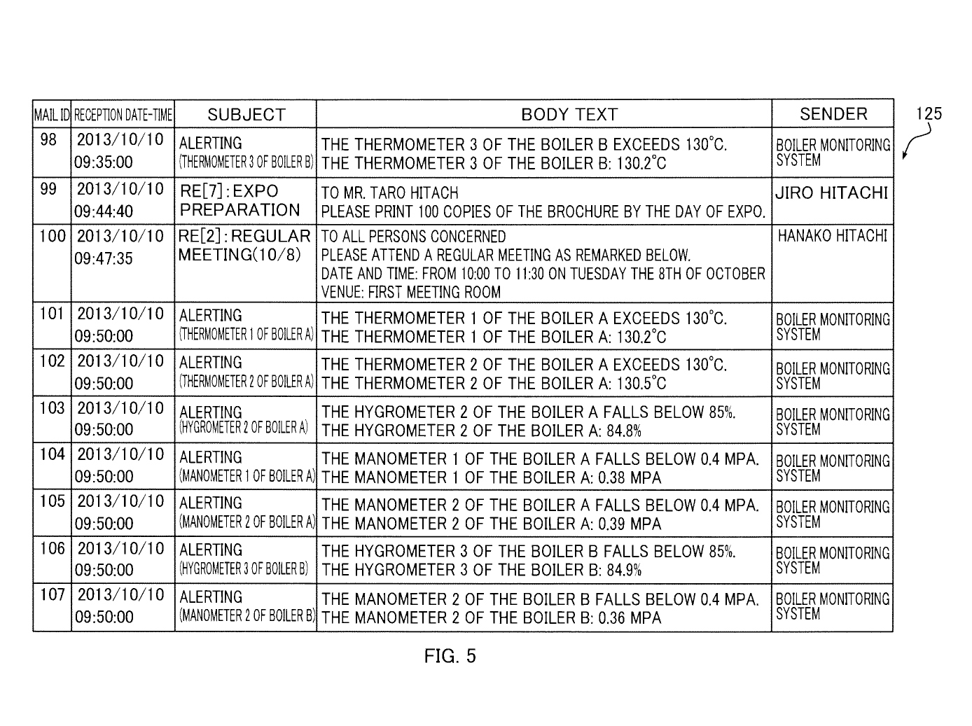

Next, description is provided for the tables retained in the auxiliary memory device 101 by the server 100 as the data transmission apparatus 100 of Embodiment 1. FIG. 5 is a diagram illustrating an example of the transmission data storage table 125 in Embodiment 1. The transmission data storage table 125 is a table storing the transmission data 51 acquired by the server 100 from the data transmission source 50. A data structure thereof is an aggregate of various data items of a mail ID, a reception date-time, a subject, a body text, and a sender of a mail corresponding to each data piece of the transmission data 51.

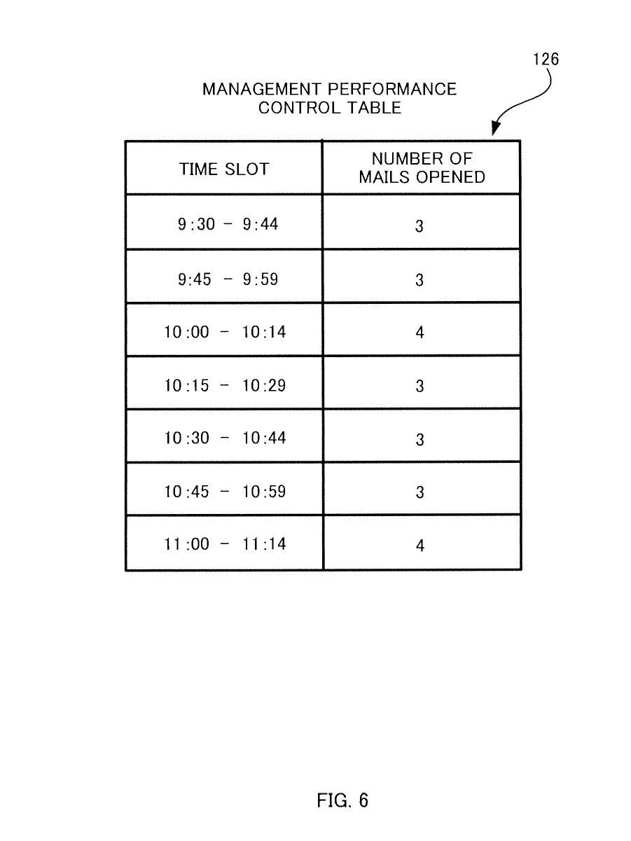

In addition, FIG. 6 is a diagram illustrating an example of the management performance control table 126 in Embodiment 1. The management performance control table 126 is a table storing information on the condition of the client 200 as a delivery destination of the transmission data 51 acquired from the data transmission source 50. Here, as the condition of the client 200, various conditions are conceivable such for example as the latest number of mails opened per unit time in the client 200, and the number of data pieces remaining in a process queue for a certain job flow in the client 200. The information on the “condition” in the example of FIG. 6 indicates the number of opening reports which are returned from the client 200, having opened mails delivered from the server 100, upon opening the mails, and which are counted by the server 100 per predetermined unit time such as 15 minutes, in short, the “condition” indicates the number of opened mails.

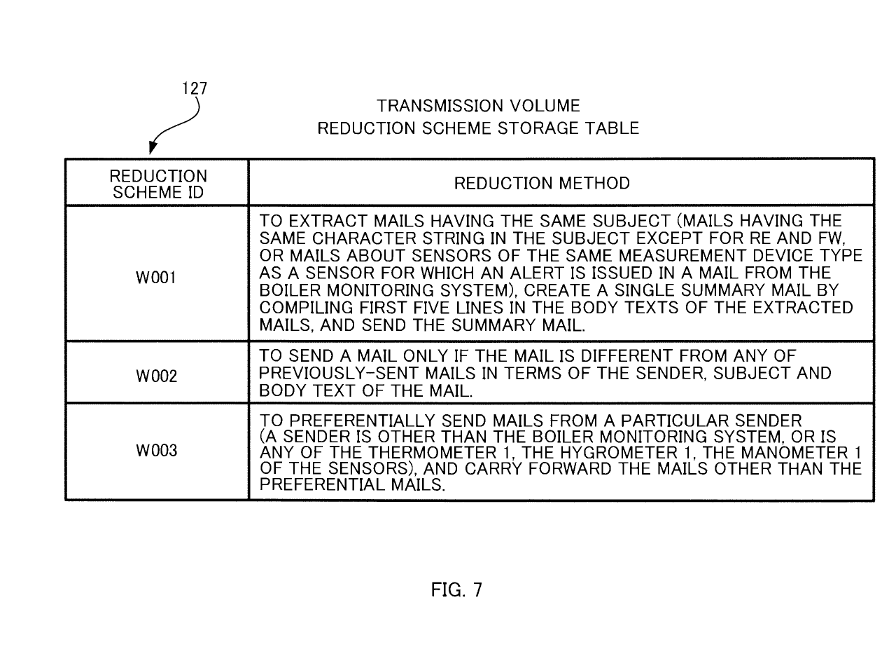

In addition, FIG. 7 is a diagram illustrating an example of the transmission volume reduction scheme storage table 127 in Embodiment 1. The transmission volume reduction scheme storage table 127 is a table storing information on various data reduction methods to be applied to the transmission data 51 for a deduplication process of redundant data, a summary process of related data, and the like. A data structure thereof is an aggregate of records each using a reduction scheme ID as a key and containing data in which details of a reduction method is described.

Note that, the transmission volume reduction scheme combination table 128 and the execution result table 129 are described later in conjunction with the following description about flows.

Hereinafter, an actual procedure of the data transmission method in the present embodiment is described based on the drawings. Various operations for carrying out the data transmission method described below are implemented by programs that the server 100 loads to the main memory device 103 and then executes. These programs are formed of codes for executing the various operations described below.

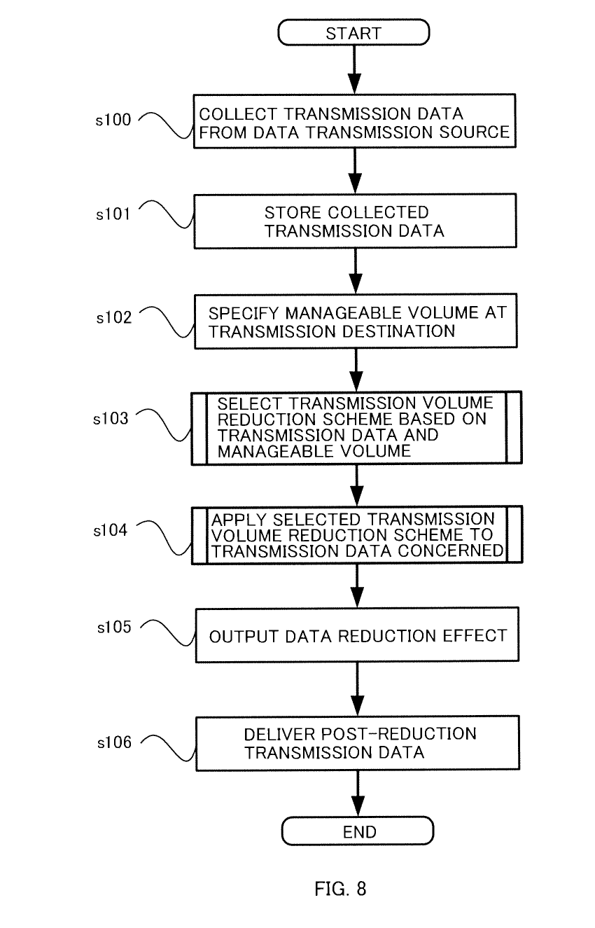

FIG. 8 is a flow chart presenting a process procedure example 1 of the data transmission method in Embodiment 1. Here, a main flow of the data transmission method is explained. In this case, the server 100 collects the transmission data 51 addressed to a certain client 200 via the communication device 105 from each data transmission source 50 such as the boiler monitoring system 70 on the network 20 (s100), and stores the transmission data 51 into the transmission data storage table 125 in the auxiliary memory device 101 (s101).

Subsequently, the server 100 specifies a data manageable volume at the destination of the transmission data 51 stored in the transmission data storage table 125 in the above step s101, namely, the client 200 (s102). The server 100 in step s102 accesses the management performance control table 126 in the auxiliary memory device 101, acquires the value of the latest number of mails opened per unit time, for example, as condition information stored with regard to the client 200, and specifies the acquired value as the data manageable volume.

Next, the server 100 performs a process of selecting a data transmission volume reduction scheme based on the aforementioned transmission data 51 and the data manageable volume specified in step s102 (s103). The details of step s103 are described later.

Then, the server 100 performs a data reduction process by applying the reduction scheme selected in step 103 described above to the aforementioned transmission data 51 (s104). The details of step s104 are also described later.

Subsequently, the server 100 sends the client 200 the transmission data volumes of the transmission data 51 before and after the reduction process with the application of the reduction scheme selected in step s103 described above (s105). Moreover, the server 100 delivers the transmission data after the reduction process in step s104 described above, namely, the post-reduction transmission data 52 to the client 200 (s106), and terminates the flow.

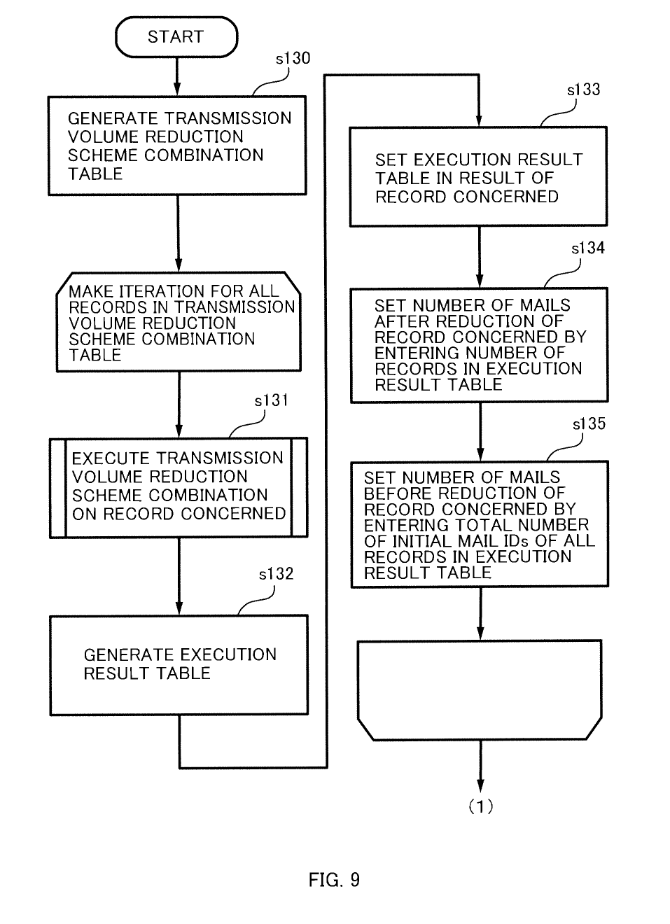

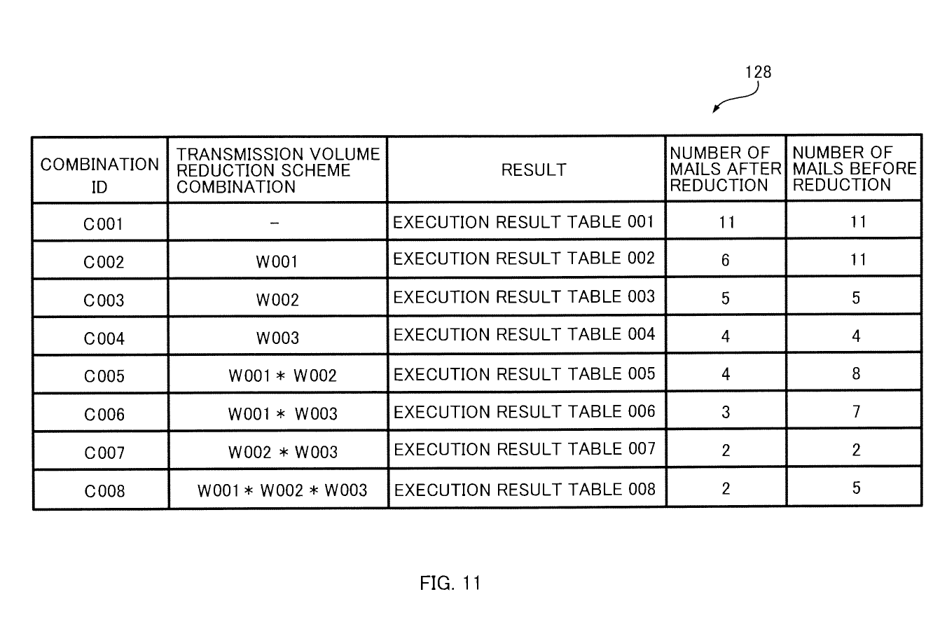

FIG. 9 is a flow chart presenting a procedure example 2 of the data transmission method in Embodiment 1. Next, the process contents in steps s103 and s104 described above are described in details. In this case, the server 100 firstly extracts the information on the data reduction methods from the transmission volume reduction scheme storage table 127 in the auxiliary memory device 101, and generates the transmission volume reduction scheme combination table 128 (see FIG. 11) by forming all the patterns each including one or a combination of more than one of the data reduction methods (s130). The transmission volume reduction scheme combination table 128 illustrated in FIG. 11 is an aggregate of records in each of which data items of a transmission volume reduction scheme combination, an execution result, the number of mails after reduction, and the number of mails before reduction are associated with each other using as a key a combination ID, which is unique to each of the transmission volume reduction scheme combination patterns.

Thereafter, the server 100 iterates the following steps s131 to s135 for all the records in the transmission volume reduction scheme combination table 128.

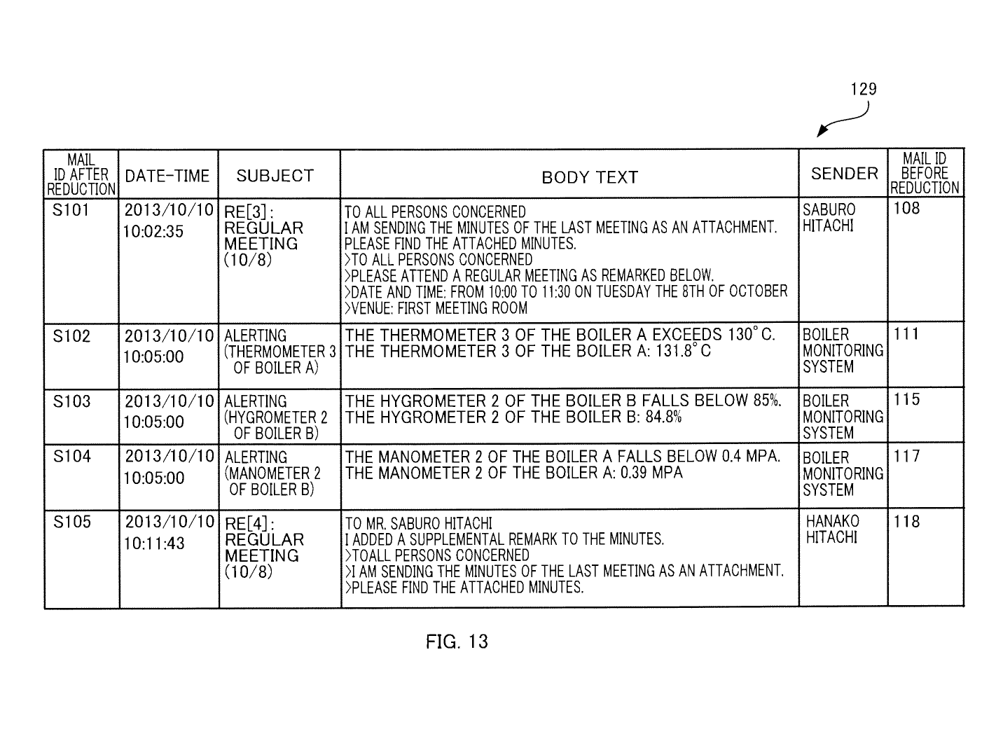

The server 100 executes the data reduction process by applying, to the transmission data 51, the reduction method indicated by each of the records in the transmission volume reduction scheme combination table 128 generated in step s130 described above (s131). In addition, with the execution of the data reduction process in step s131, the server 100 generates the execution result table 129 (see FIGS. 13 to 15) for each of the transmission volume reduction scheme combination patterns specified in the respective records in the transmission volume reduction scheme combination table 128, and stores the execution result table 129 into the auxiliary memory device 101 (s132). Here, the execution result table 129 is a table for storing data reduction results obtained by the corresponding transmission volume reduction scheme combination pattern.

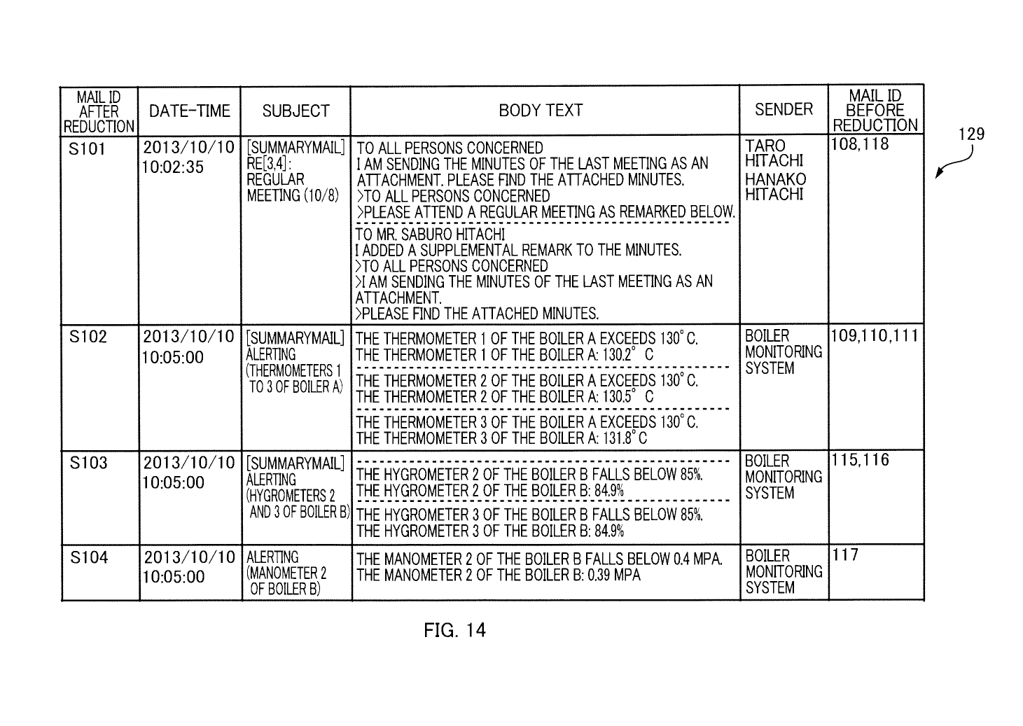

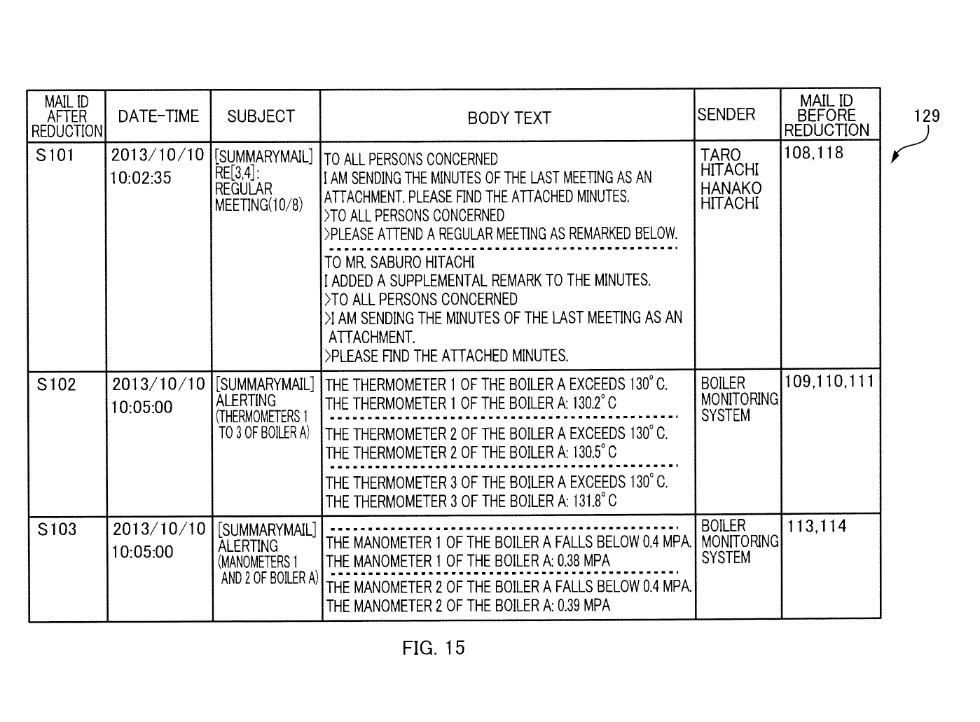

The execution result table 129 illustrated in FIG. 13 presents post-reduction transmission data obtained by data reduction with the application of a transmission volume reduction scheme “W002”, the execution result table 129 illustrated in FIG. 14 presents post-reduction transmission data obtained by data reduction with the application of AND operation of transmission volume reduction schemes “W001” and “W002”, and the execution result table 129 illustrated in FIG. 15 presents post-reduction transmission data obtained by data reduction with the application of AND operation of transmission volume reduction schemes “W001” and “W003”.

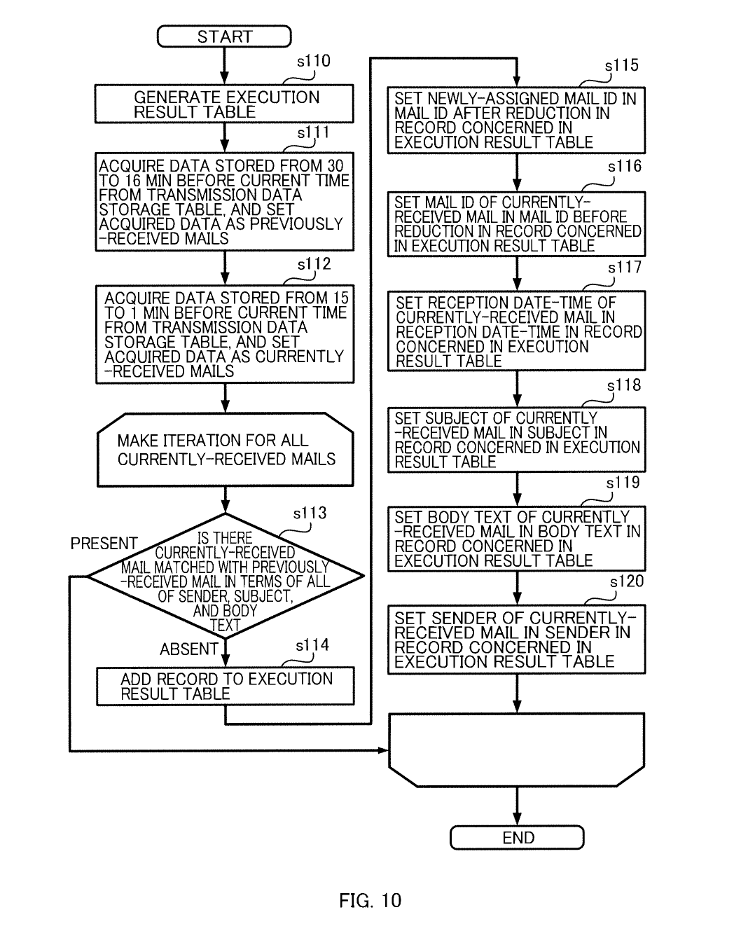

The details of steps s131 and s132 described above are just as presented in FIG. 10. FIG. 10 is a flow chart presenting a procedure example 3 of the data transmission method in Embodiment 1. This chart presents a process procedure of steps s131 and s132 for executing data reduction by the server 100 with the application of the aforementioned transmission volume reduction scheme “W002”.

Here, the server 100 generates the execution result table 129 specialized for the transmission volume reduction scheme “W002” (s110). Then, the server 100 acquires the transmission data 51, which is addressed to the certain client 200 and is received from 30 minutes to 16 minutes before the current time, from the transmission data storage table 125 in the auxiliary memory device 101, and temporarily stores the acquired transmission data 51 as previously-received mails in the main memory device 103 (s111).

After that, the server 100 acquires the transmission data 51, which is addressed to the above client 200 and is received from 15 minutes to 1 minute before the current time, from the transmission data storage table 125, and temporarily stores the acquired transmission data 51 as currently-received mails in the main memory device 103 (s112). Thereafter, the server 100 iterates steps s113 to s120 described later to process all the aforementioned currently-received mails.

Subsequently, the server 100 performs matching between the aforementioned previously-received mails and currently-received mails retained in the main memory device 103, and judges whether there is a currently-received mail matched with any of the previously-received mails in terms of all of the sender, the subject, and the body text (s113). If the currently-received mail matched with the previously-received mail in terms of all of the sender, the subject, and the body text is found as a result of this judgment (s113: present), the server 100 avoids a process for the currently-received mail concerned. On the other hand, if the currently-received mail matched with the previously-received mail in terms of all of the sender, the subject, and the body text is not found (s113: absent), the server 100 adds the currently-received mail, being a process target in the on-going routine, as a record to the aforementioned execution result table 129 generated in step s110 (s114).

Next, in the record concerned in the aforementioned execution result table 129 generated in step s110, the server 100 sets a field of “MAIL ID AFTER REDUCTION” by entering a mail ID newly assigned to the currently-received mail concerned (s115). In addition, in the record concerned in the aforementioned execution result table 129 generated in step s110, the server 100 sets a field of “MAIL ID BEFORE REDUCTION” by entering a mail ID already assigned to the currently-received mail concerned at the process stage of step s101 (s116).

Moreover, in the record concerned in the aforementioned execution result table 129 generated in step s110, the server 100 sets a field of “RECEPTION DATE-TIME” by entering the reception date-time of the currently-received mail concerned (s117). Further, in the record concerned in the aforementioned execution result table 129 generated in step s110, the server 100 sets a field of “SUBJECT” by entering the data of the subject contained in the currently-received mail concerned (s118).

Then, in the record concerned in the aforementioned execution result table 129 generated in step s110, the server 100 sets a field of “BODY TEXT” by entering the data of the body text contained in the currently-received mail concerned (s119). Additionally, in the record concerned in the aforementioned execution result table 129 generated in step s110, the server 100 sets a field of “SENDER” by entering the data of the sender contained in the currently-received mail concerned (s120). By the process thus far, the execution result table 129 in which the actual data is set is generated. The foregoing flow (s110 to s120) is executed for each of the reduction method patterns indicated by the respective records in the transmission volume reduction scheme combination table 128.

Here, the description gets back to the process after step s132 described above. Subsequently, the server 100 associates information on the process result in step s131 described above, that is, information on the execution result table 129 obtained by applying the reduction method indicated by each record in the transmission volume reduction scheme combination table 128, with the record for the pattern of the reduction method concerned in the transmission volume reduction scheme combination table 128 (s133).

In the example illustrated in FIG. 11, in the transmission volume reduction scheme combination table 128, “RESULT” of the data reduction executed with the application of the transmission volume reduction scheme combination “W002” of the combination ID “C003” is set to have a value of “EXECUTION RESULT TABLE 003” indicating the execution result table 129 illustrated in FIG. 13. Similarly, “RESULT” of the data reduction executed with the application of the transmission volume reduction scheme combination “W001”×“W002” of the combination ID “C005” is set to have a value of “EXECUTION RESULT TABLE 005” indicating the execution result table 129 illustrated in FIG. 14. Also similarly, “RESULT” of the data reduction executed with the application of the transmission volume reduction scheme combination “W001”×“W003” of the combination ID “C006” is set to have a value of “EXECUTION RESULT TABLE 006” indicating the execution result table 129 illustrated in FIG. 15.

Next, in the record concerned, as the process target in s133 described above, the server 100 sets a field of “NUMBER OF MAILS AFTER REDUCTION” in the transmission volume reduction scheme combination table 128 by entering the number of records in the execution result table 129 associated with the record concerned in s133 described above (s134). For example, the field of “NUMBER OF MAILS AFTER REDUCTION” in the record of the combination ID “C003” is set to have a value “5” which is the number of records in the execution result table 129 illustrated in FIG. 13. Similarly, the field of “NUMBER OF MAILS AFTER REDUCTION” in the record of the combination ID “C005” is set to have a value “4” which is the number of records in the execution result table 129 illustrated in FIG. 14. Also similarly, the field of “NUMBER OF MAILS AFTER REDUCTION” in the record of the combination ID “C006” is set to have a value “3” which is the number of records in the execution result table 129 illustrated in FIG. 15.

Thereafter, in the record concerned, as the process target in s133 described above, the server 100 sets a field of “NUMBER OF MAILS BEFORE REDUCTION” in the transmission volume reduction scheme combination table 128 by entering the total number of initial mail IDs of the records in the execution result table 129 associated with the record concerned in s133 described above (s135). For example, the field of “NUMBER OF MAILS BEFORE REDUCTION” in the record of the combination ID “C003” is set to have a value “5” which is the total number of initial mail IDs in the execution result table 129 illustrated in FIG. 13. Similarly, the field of “NUMBER OF MAILS BEFORE REDUCTION” in the record of the combination ID “C005” is set to have a value “8” which is the total number of initial mail IDs in the execution result table 129 illustrated in FIG. 14. Also similarly, the field of “NUMBER OF MAILS BEFORE REDUCTION” in the record of the combination ID “C006” is set to have a value “7” which is the total number of the initial mail IDs in the execution result table 129 illustrated in FIG. 15.

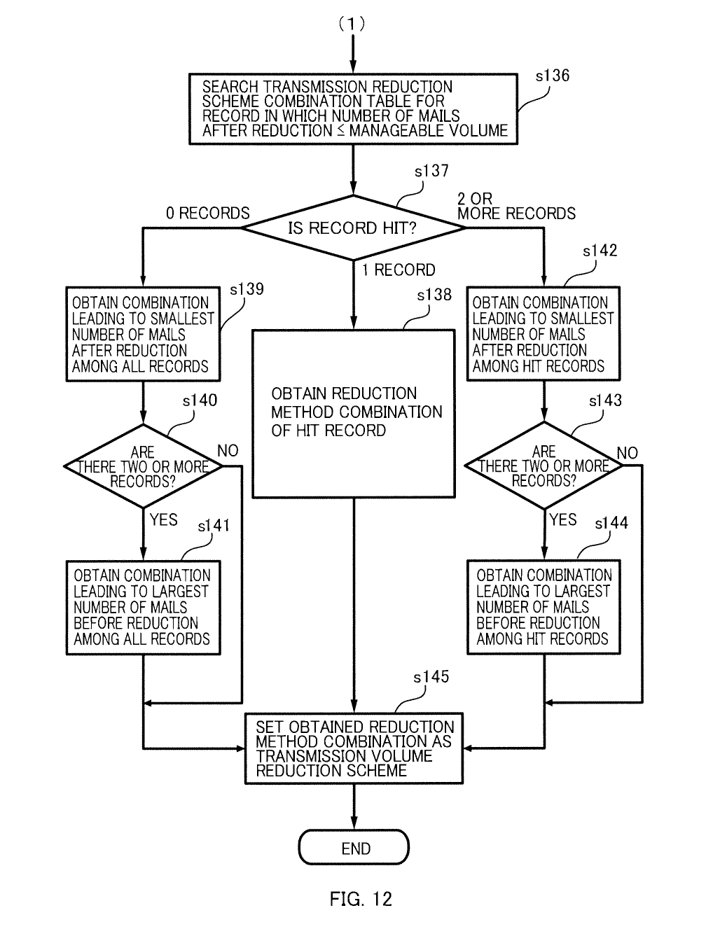

FIG. 12 is a diagram presenting a procedure example 4 of the data transmission method in Embodiment 1. Subsequently, the server 100 searches the transmission volume reduction scheme combination table 128 for a record in which the value in the field of “NUMBER OF MAILS AFTER REDUCTION” is equal to or lower than the number of mails opened in the latest time slot in the management performance control table 126, that is, the manageable volume (s136). Here, “4” which is the number of mails opened in the time slot of “11:00-11:14” is used as the manageable volume. Then, in the transmission volume reduction scheme combination table 128 in FIG. 11, the records of the combination IDs “C004” to “C008” can be determined as records in which “NUMBER OF MAILS AFTER REDUCTION” is that value of 4 or less.

If the number of hit records obtained as a result of the search in step s136 is one (s137: 1 record), the server 100 obtains information on the reduction method combination indicated by the hit record (s138), and sets the reduction method combination obtained here as the transmission volume reduction scheme (s145).

On the other hand, if the number of hit records obtained as a result of the search in step s136 is zero (s137: 0 records), the server 100 obtains the reduction method combination of the record having the smallest value in “NUMBER OF MAILS AFTER REDUCTION” among all the records in the transmission volume reduction scheme combination table 128 (s139). Here, if the number of combinations obtained in step s139 is more than one (s140: Yes), the server 100 obtains the reduction method combination of the record having the largest number of mails before reduction among all the records in the transmission volume reduction scheme combination table 128 (s141), and sets the reduction method combination obtained here as the transmission volume reduction scheme (s145). Meanwhile, if the number of combinations obtained in step s139 is one (s140: No), the server 100 sets the reduction method combination obtained in step s139 as the transmission volume reduction scheme (s145).

On the other hand, if the number of hit records obtained as a result of the search in step s136 is two or more (s137: two or more records), the server 100 obtains the reduction method combination of the record having the largest “NUMBER OF MAILS AFTER REDUCTION” among the hit records (s142). In the example of the transmission volume reduction scheme combination table 128 illustrated in FIG. 11, the server 100 obtains the reduction method combinations indicated by the two records of the combination IDs “C004” and “C005” among the records of the combination IDs “C004” to “C008”.

Here, if the number of reduction method combinations obtained in step s142 is more than one (s143: Yes), the server 100 obtains the reduction method combination of the record having the largest “NUMBER OF MAILS BEFORE REDUCTION” among the hit records (s144), and sets the reduction method combination obtained here as the transmission volume reduction scheme (s145). In the aforementioned example, the reduction method combination of “C005” out of the two records of the combination IDs “C004” and “C005” is set as the transmission volume reduction scheme.

Meanwhile, if the number of reduction method combinations obtained in step s142 is one (s143: No), the server 100 sets the reduction method combination obtained in step s142 as the transmission volume reduction scheme (s145).

As a result of the above, the transmission volume reduction scheme determined in step s145 described above can be applied to the transmission data, i.e., mails transmitted from the data transmission source 50 such as the boiler monitoring system 70 to reduce the data volume, and the post-reduction transmission data 52 thus obtained can be transmitted to the client 200. This allows the user using the client 200 to browse the mails, the number of which is reduced to the manageable number, without having any particular burden, and enables effective reduction in a risk that a mail requiring responsive care may be overlooked.

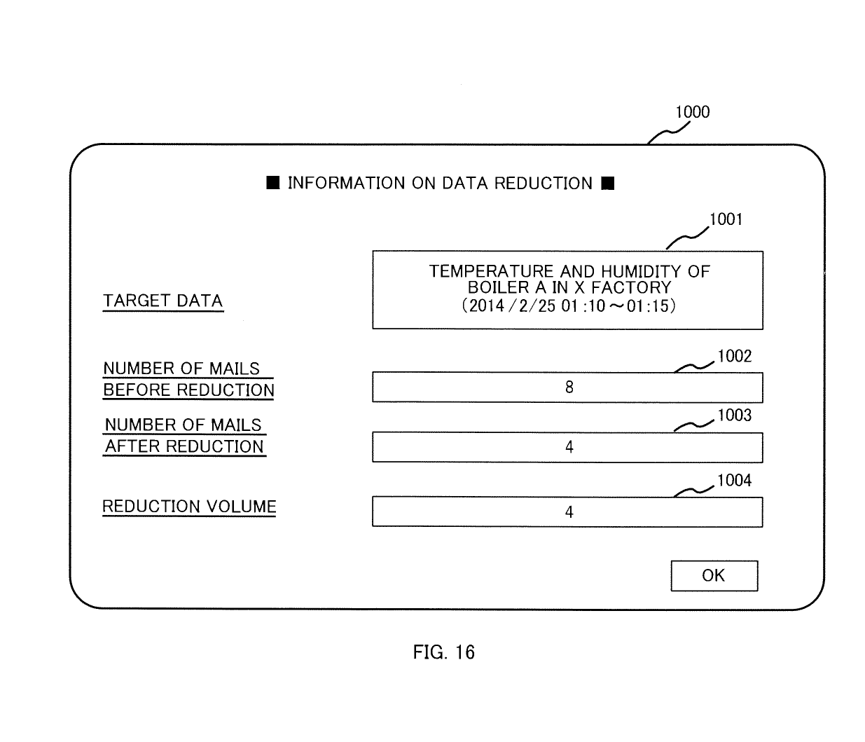

Note that, as described in step s105 in the flow of FIG. 8, the server 100 sends the client 200 the transmission data volumes of the transmission data 51 before and after the reduction process with the application of the transmission volume reduction scheme, i.e., the reduction method combination, determined in step s145. In this case, the server 100 creates data of a reduction effect output screen at least containing information indicating “4” as the number of mails after reduction and “8” as the number of mails before reduction in the case of using the reduction method combination “C005” as the transmission volume reduction scheme, and transmits the created data to the client 200. FIG. 16 is a diagram illustrating an example of an output screen in Embodiment 1. A screen 1000 illustrated here is the aforementioned reduction effect output screen, and contains a content 1001 of the transmission data 51 targeted for the reduction, and the values of the number of mails before reduction 1002, the number of mails after reduction 1003, and a reduction volume 1004. Viewing such a screen 1000 on the client 200, the user can easily and clearly recognize how effectively the number of mails is reduced.

In Embodiment 1 described above, if there is more than one reduction method combination capable of reducing the transmission data 51, i.e., the number of mails, to or below the manageable volume of the user of the client 200, the combination leading to the largest number of mails after reduction is selected. In contrast to this, the following description is provided for another process which does not involve selecting the combination leading to the largest number of mails after reduction. Specifically, this process involves giving a higher priority to a higher content of certain data designated by a user in advance, and selecting a combination having a high priority to transmit significant data desired by the user. Here, only points different from those in Embodiment 1 described above are described.

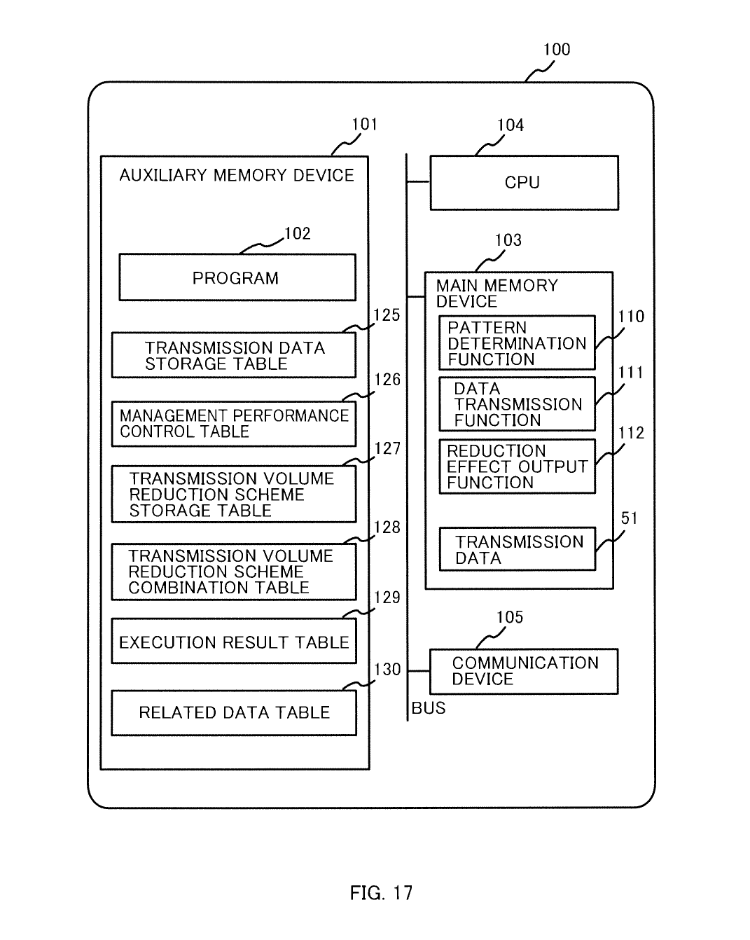

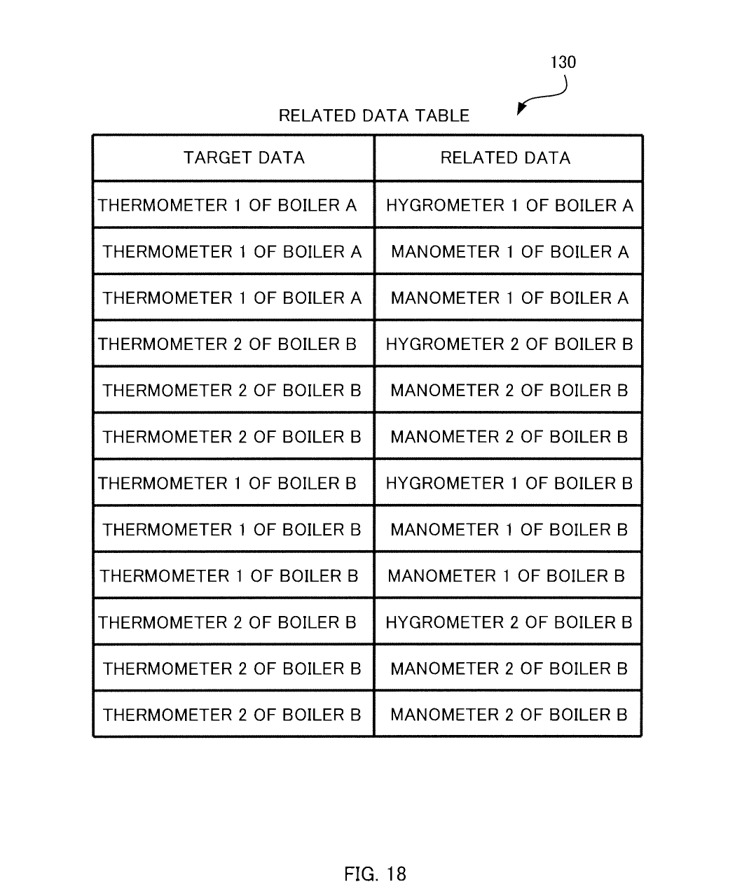

FIG. 17 is a configuration diagram of a network including a server 100 as a data transmission apparatus in Embodiment 2. Unlike the server 100 of Embodiment 1, the server 100 in Embodiment 2 includes a related data table 130 in an auxiliary memory device 101. This related data table 130 is a table storing data sets in each of which target data is associated with related data as illustrated in FIG. 18. These sets are data sets admitted to be significant by a user of a client 200.

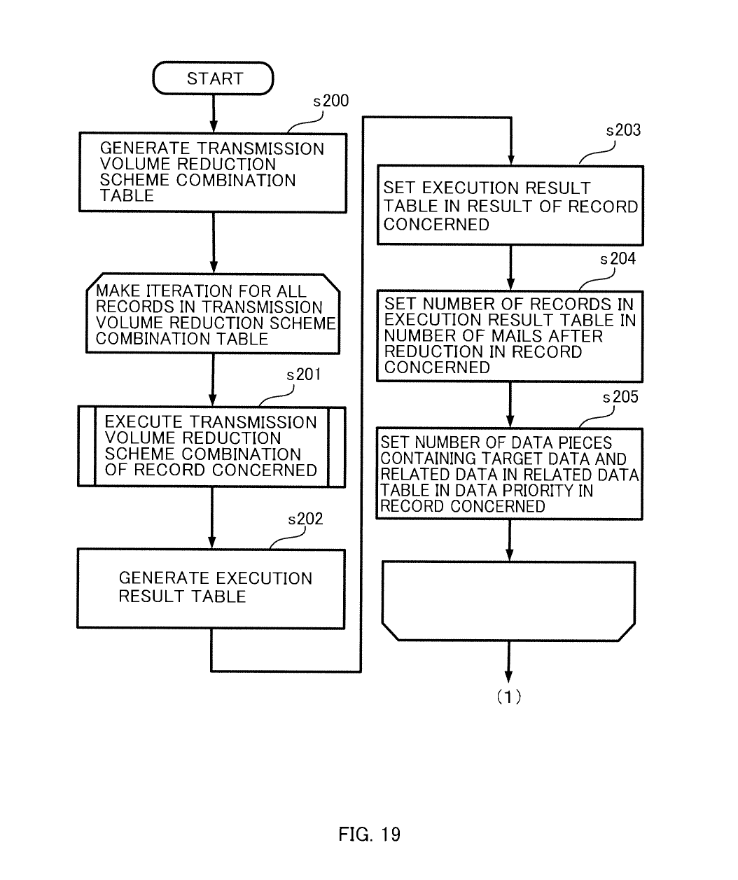

In this case, as illustrated in a flow in FIG. 19, the server 100 first executes the same process (s200 to s240) as in steps s130 to s134 in the flow in FIG. 9. After that, for each of the reduction method combinations indicated by the respective records in the transmission volume reduction scheme combination table 128, the server 100 counts the number of mails containing the sets (target data and related data) indicated in the aforementioned related data table 130 among the mails after reduction with the application of the combination concerned, and sets a field of “DATA PRIORITY” in the record concerned by entering the counted number of the mails containing the target data and the related data (s205).

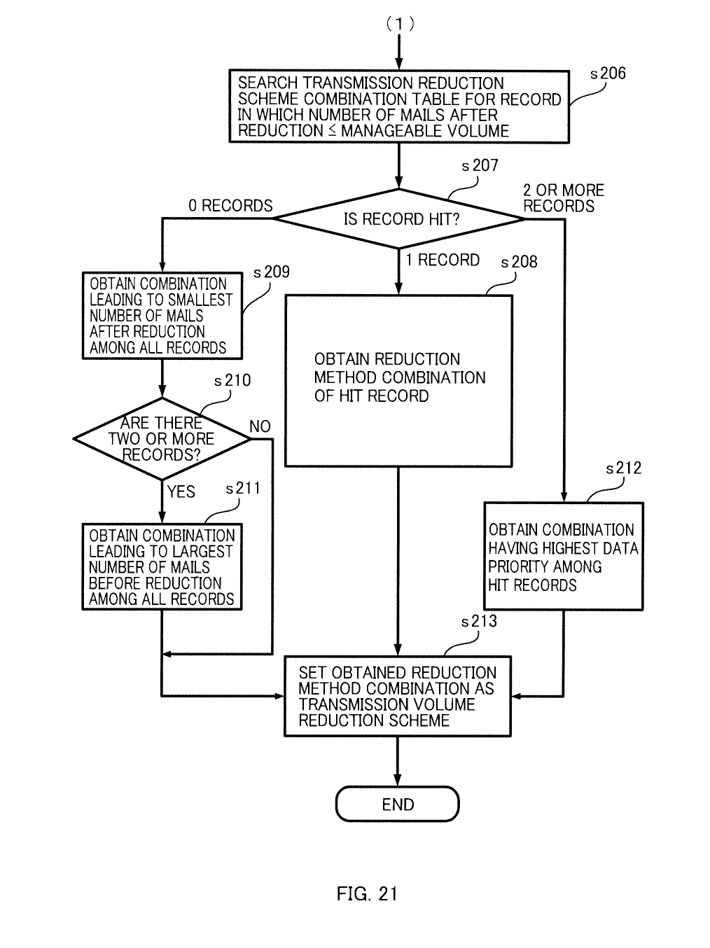

Then, as illustrated in a flow in FIG. 21, the server 100 executes the same process (s206 to s211) as insteps s136 to s141 in the flow in FIG. 12, and searches the transmission volume reduction scheme combination table 128 for records in each of which the value in the field of “NUMBER OF MAILS AFTER REDUCTION” is equal to or lower than the number of mails opened in the latest time slot in the management performance control table 126, or the manageable volume in short. In addition to the aforementioned same process, if the number of obtained hit records is two or more as a result of the search (s207: two or more records), the server 100 obtains the reduction method combination of the record having the largest value in “DATA PRIORITY” among the hit records (s212).

In the example of the transmission volume reduction scheme combination table 128 illustrated in FIG. 11, the server 100 obtains the reduction method combination indicated by the record of the combination ID “C006” having the largest value “2” in the data priority among the records of the combination IDs “C004” to “C008”.

As a result of the above, the transmission volume reduction scheme determined in step s212 described above can be applied to the transmission data, i.e., mails transmitted from the data transmission source 50 such as the boiler monitoring system 70 to reduce the data volume, and the post-reduction transmission data 52 thus obtained can be transmitted to the client 200. This allows the user using the client 200 to browse the mails, the number of which is reduced to the manageable number, without having any particular burden, and enables effective reduction in a risk that a mail requiring responsive care and its related mail may be overlooked.

Note that, as described in step s105 in the flow in FIG. 8, the server 100 sends the client 200 the transmission data volumes of the transmission data 51 before and after the reduction process with the application of the transmission volume reduction scheme selected in step s212 described above. In this case, the server 100 creates data of a reduction effect output screen at least containing information indicating “3” as the number of mails after reduction and “7” as the number of mails before reduction in the case of using the reduction method combination “C006” as the transmission volume reduction scheme, and transmits the created data to the client 200. FIG. 226 is a diagram illustrating an example of an output screen in Embodiment 2. A screen 1500 illustrated here is the aforementioned reduction effect output screen, and contains a content 1501 of the transmission data 51 targeted for the reduction, considered related data 1502, and the values of the number of mails before reduction 1503, the number of mails after reduction 1504, and a reduction volume 1505. Viewing such a screen 1500 on the client 200, the user can certainly recognize the desired data to be considered, and moreover can easily and clearly recognize how effectively the number of mails is reduced.

According to the present embodiment, even if the volume of data is huge, the data reduced to or below the volume manageable on the recipient side can be transmitted. In addition, it is possible to transmit data in which data particularly significant on the recipient side is prevented from being eliminated, while the data volume is reduced to or below the volume manageable on the recipient side. This prevents the recipient side from overlooking data and enables the recipient side to appropriately deal with the data. Thus, the necessary data in the appropriate volume suitable for the condition of the recipient side can be transmitted.

The description of this specification clarifies at least the following matters. Specifically, the data transmission method in the present embodiment may include a pattern determination process in which if two or more patterns capable of reduction to or below the limitation volume are hit, the information processing apparatus determines the pattern leading to the largest volume of the transmission data after the reduction among the hit patterns.

This makes it possible to maximize the data volume or information volume to be received and noticed by a person while keeping the data volume at level manageable on the recipient side, so that the person receiving the data can deal with a lot of information efficiently without having excessive burden.

In addition, in the data transmission method of the present embodiment, the information processing apparatus may perform the pattern determination process further including: executing a process of counting, for each of the patterns, the number of transmission data pieces containing certain attribute data determined in advance among the transmission data after the reduction with the application of the pattern; and, if two or more patterns capable of reduction to or below the limitation volume are hit, determining the pattern leading to the largest number of transmission data pieces containing the certain attribute data among the hit patterns.

This makes it possible to maximize the volume of important data to be preferentially noticed and dealt with by a person receiving the data, while reducing the data volume to the level manageable on the recipient side, so that the person can deal with a lot of significant information efficiently without having excessive burden.

In addition, in the data transmission method of the present embodiment, the information processing apparatus may additionally execute a reduction effect output process of sending the client the transmission data volumes of the transmission data before and after the transmission data reduction process with the application of the data reduction method of the determined pattern.

This enables the person receiving the data to specifically know the data reduction effect.

### REFERENCE SIGNS LIST

20 network
50 data transmission source
51 transmission data
52 post-reduction transmission data
100 server (data transmission apparatus)
101 auxiliary memory device
102 program
103 main memory device
104 CPU (arithmetic device)
105 communication device
125 transmission data storage table
126 management performance control table
127 transmission volume reduction scheme storage table
128 transmission volume reduction scheme combination table
129 execution result table
130 related data table
200 client

1. A data transmission method executed by an information processing apparatus including a memory device that stores information on transmission data, a condition of a client as a data transmission destination, and information on a plurality of data reduction methods, the method comprising causing the information processing apparatus to execute:
a pattern determination process of calculating, for each pattern including one or a combination of more than one of the data reduction methods, a transmission data volume of the transmission data after reduction with application of the pattern concerned, and determining a pattern capable of reduction to or below a transmission data limitation volume suitable for the condition of the client; and
a data transmission process of executing a reduction process on the transmission data by use of the data reduction method of the determined pattern, and sending the client the transmission data after the reduction process.

2. The data transmission method according to claim 1, wherein
in the pattern determination process, if two or more patterns capable of reduction to or below the limitation volume are hit, the information processing apparatus determines the pattern leading to the largest transmission data volume after the reduction among the hit patterns.

3. The data transmission method according to claim 1, wherein
in the pattern determination process, for each of the patterns, the information processing apparatus further executes a process of counting the number of data pieces containing certain attribute data determined in advance among the transmission data after the reduction with the application of the pattern concerned, and
if two or more patterns capable of reduction to or below the limitation volume are hit, the information processing apparatus determines the pattern leading to the largest number of data pieces containing the certain attribute data among the hit patterns.

4. The data transmission method according to claim 1, wherein
the information processing apparatus further executes a reduction effect output process of sending the client transmission data volumes of the transmission data before and after the reduction process with application of the data reduction method of the determined pattern.

5. A data transmission apparatus comprising:
a memory device that stores information on transmission data, a condition of a client as a data transmission destination, and information on a plurality of data reduction methods; and
an arithmetic device configured to execute
a process of calculating, for each pattern including one or a combination of more than one of the data reduction methods, a transmission data volume of the transmission data after reduction with application of the pattern concerned, and determining a pattern capable of reduction to or below a transmission data limitation volume suitable for the condition of the client, and
a process of executing a reduction process on the transmission data by using the data reduction method of the determined pattern, and sending the client the transmission data after the reduction process.
